(19) United States
(12) Patent Application Publication
(10) Pub. No.: US 2010/0318829 A1
(43) Pub. Date: Dec. 16, 2010

(54) NETWORK DEVICE

(75) Inventor: Nobuhiro TAMURA, Nagoya (JP)

Correspondence Address: Beyer Law Group LLP, P.O. BOX 1687, Cupertino, CA, 95015-1687, US

(73) Assignee: BUFFALO INC., Nagoya-shi (JP)

(21) Appl. No.: 12/797,549

(22) Filed: Jun. 9, 2010

(30) Foreign Application Priority Data
Jun. 10, 2009 (JP) 2009-138818

(51) Int. Cl. G06F 1/30

(52) U.S. Cl. 713/340; 713/300

(57) ABSTRACT

The access point 100 includes a network connection section (an RF device 60 and an antenna 70, and Ethernet controller 50, a LAN port 52, or a WAN port 53) for connecting to a network (a wireless LAN, a wired LAN, or a WAN); a USB port 42 for connecting a USB device; and a power supply controller 12 for controlling power supply to the USB device from the USB port 42 based on connection status between the network and the network connection section. The power supply controller 12 distributes power to the USB device on the condition that a communication link was established between the network and the network connection section. If all communication links between the network and the network connection section are disconnected, the power supply controller 12 suspends power supply to the USB device.

### BACKGROUND

1. Technical Field

The present invention relates to a network device.

2. Related Art

As the Internet has grown, various types of network devices adapted for connection to networks such as LANs (Local Area Networks) have become increasingly widespread. In recent years, network devices designed to accommodate connection of USB devices compliant with the USB (Universal Serial Bus) standard (e.g. a so-called USB hard disk or the like) have become common as well. Such network devices enable a USB device connected to the network device to be utilized from personal computers or other devices connected to the network.

The design of the conventional network devices is such that, with a USB device connected, as long as power to the network device is powered on, power is constantly supplied to the USB device from the network device irrespective of the connection status between the networks and the network device, and is consumed by the USB device the entire time. Accordingly, there exists a need to reduce power consumption by network devices.

An advantage of some aspects of the invention is to reduce power consumption of a network device having a USB device connected.

The entire disclosure of Japanese patent application No. 2009-138818 of BUFFALO is hereby incorporated by reference into this document.

### SUMMARY

The present invention, which has been made to attain the above objects at least in part, can be realized in the following modes of practice.

According to a first aspect of the invention, there is provided:

a network device comprising:

a network connection section to be connected to a network;

a USB connection section to which a USB device is connected and which supplies power to the USB device; and

a power supply controller to control power supply to the USB device from the USB connection section based on the connection status between the network and the network connection section.

According to the network device of the first aspect, the power supply controller can perform appropriate ON/OFF control of power supply to a USB device from the USB connection section, based on the connection status of the network and the network connection section. Thus, power consumption by the network device with the USB device connected can be reduced. Herein, the term “connection status” is used to include both physical connection status and communication connection status.

According to a second aspect of the invention, there is provided:

the network device in accordance with the first aspect wherein

the network include a wireless LAN,

the network connection section includes a wireless LAN connection section which is connected to the wireless LAN, and

the power supply controller controls power supply to the USB device from the USB connection section based on connection status between the wireless LAN and the wireless LAN connection section.

According to the network device of the second aspect, the power supply controller can perform appropriate ON/OFF control of power supply to a USB device from the USB connection section based on the connection status of the wireless LAN and the wireless LAN connection section. Thus, power consumption by the network device can be reduced.

According to a third aspect of the invention, there is provided

the network device in accordance with the second aspect wherein

the power supply controller supplies power to the USB device when a communication link is established between the wireless LAN and the wireless LAN connection section.

In the absence of a communication link between the wireless LAN and the wireless LAN connection section, access to the USB device connected to the network device from the wireless LAN does not take place. Accordingly, there is no need for the USB device to be supplied with power for the purpose of accessing the USB device from the wireless LAN. According to the network device of the third aspect, if a communication link is established between the wireless LAN and the wireless LAN connection section, the power supply controller supplies power to the USB device from the USB connection section so that the system can promptly respond to access to the USB device from the wireless LAN once a communication link is established between the wireless LAN and the wireless LAN connection section.

According to a fourth aspect of the invention, there is provided:

the network device in accordance with the second aspect wherein

the power supply controller supplies power to the USB device when a communication link is established between the wireless LAN and the wireless LAN connection section and additionally an access to the USB device takes place from the wireless LAN.

Even if a communication link is established between the wireless LAN and the wireless LAN connection section, access to the USB device connected to the network device from the wireless LAN will not always take place. According to the network device of the fourth aspect, the power supply controller supplies power to the USB device from the USB connection section when a communication link is established between the wireless LAN and the wireless LAN connection section, and additionally an access to the USB device from the wireless LAN takes place. In other words, according to the network device of the fourth aspect, even if a communication link is established between the wireless LAN and the wireless LAN connection section, the power supply controller does not supply power to the USB device from the USB connection section unless an access to the USB device from the wireless LAN takes place. Thus, with the network device of the present aspect, power consumption can be reduced to a lower level than with the network device of the third aspect.

According to a fifth aspect of the invention, there is provided

the network device in accordance with any of the first to fourth aspects wherein

the network include a wired LAN,

the network connection section include a wired LAN connection section connected to the wired LAN, and

the power supply controller controls power supply to the USB device from the USB connection section based on the connection status between the wired LAN and the wired LAN connection section.

According to the network device of the fifth aspect, the power supply controller can perform appropriate ON/OFF control of power supply to a USB device from the USB connection section based on the connection status of the wired LAN and the wired LAN connection section. Thus, power consumption by the network device can be reduced.

According to a sixth aspect of the invention, there is provided

the network device in accordance with the fifth aspect wherein

the power supply controller supplies power to the USB device when a communication link is established between the wired LAN and the wired LAN connection section.

In the absence of a communication link between the wired LAN and the wired LAN connection section, an access to the USB device connected to the network device from the wired LAN does not take place. Accordingly there is no need for the USB device to be supplied with power for the purpose of accessing the USB device from the wired LAN. According to the network device of the sixth aspect, if a communication link is established between the wired LAN and the wired LAN connection section, the power supply controller supplies power to the USB device from the USB connection section so that the system can promptly respond to an access to the USB device from the wired LAN once a communication link is established between the wired LAN and the wired LAN connection section.

According to a seventh aspect of the invention, there is provided:

the network device in accordance with the fifth aspect wherein

the power supply controller supplies power to the USB device when a communication link is established between the wired LAN and the wired LAN connection section, and additionally an access to the USB device takes place from the wired LAN.

Even if a communication link is established between the wired LAN and the wired LAN connection section, it is not inevitable that access to the USB device connected to the network device from the wired LAN will take place. According to the network device of the seventh aspect, the power link controller supplies power to the USB device from the USB connection section if a communication link is established between the wired LAN and the wired LAN connection section, and additionally an access to the USB device from the wired LAN takes place. In other words, according to the network device of the seventh aspect, even if a communication link is established between the wired LAN and the wired LAN connection section, the power supply controller does not supply power to the USB device from the USB connection section unless an access to the USB device takes place from the wired LAN. Thus, with the network device of the present aspect, power consumption can be reduced to a lower level than with the network device of the sixth aspect.

According to an eighth aspect of the invention, there is provided

the network device in accordance with the sixth or seventh aspect wherein

the power supply controller decides that a communication link is established between the wired LAN and the wired LAN connection section, if the wired LAN connection section receives from the wired LAN at least one of an ARP packet, a DHCP packet, a UPnP packet, and a link pulse signal.

According to the network device of the eighth aspect, the power supply controller monitors ARP (Address Resolution Protocol) packets, DHCP (Dynamic Host Configuration Protocol) packets, UPnP (Universal Plug and Play) packets, and link pulse signals received by the wired LAN connection section; and if the wired LAN connection section receives at least one of these packets and signals, the power supply controller decides that a communication link has been established between the wired LAN and the wired LAN connection section.

According to a ninth aspect of the invention, there is provided

the network device in accordance with any of the first to eighth aspects wherein

the network include a WAN;

the network connection section include a WAN connection section connected to the WAN; and

the power supply controller controls power supply to the USB device from the USB connection section, based on the connection status between the WAN and the WAN connection section.

According to the network device of the ninth aspect, the power supply controller can control the ON/OFF of the power supply to a USB device from the USB connection section based on connection status of a WAN (Wide Area Network) and the WAN connection section. Thus, power consumption by the network device can be reduced.

According to a tenth aspect of the invention, there is provided:

the network device in accordance with the ninth aspect wherein

the power supply controller supply power to the USB device when a communication link is established between the WAN and the WAN connection section.

In the absence of a communication link between the WAN and the WAN connection section, an access to the USB device connected to the network device from the WAN does not take place. Accordingly there is no need for the USB device to be supplied with power for the purpose of accessing the USB device from the WAN. According to the network device of the tenth aspect, if a communication link is established between the WAN and the WAN connection section, the power supply controller supplies power to the USB device from the USB connection section so that the system can promptly respond to the access to the USB device from the WAN once a communication link is established between the WAN and the WAN connection section.

According to an eleventh aspect of the invention, there is provided

the network device in accordance with the tenth aspect wherein

the power supply controller supplies power to the USB device when a communication link is established between the WAN and the WAN connection section and additionally an access to the USB device takes place from the WAN.

Even if a communication link is link between the WAN and the WAN connection section, an access to the USB device connected to the network device will not always take place from the WAN. According to the network device of the eleventh aspect, the power supply controller supplies power to the USB device from the USB connection section when a communication link is established between the WAN and the WAN connection section, and an access to the USB device takes place from the WAN. In other words, according to the network device of the eleventh aspect, even if a communication link is established between the WAN and the WAN connection section, the power supply controller does not supply power to the USB device from the USB connection section unless access of the USB device takes place from the WAN. Thus, with the network device of the present aspect, power consumption can be reduced to a lower level than with the network device of the tenth aspect.

According to a twelfth aspect of the invention, there is provided

the network device in accordance with any of the first to eleventh aspects wherein

the power supply controller interrupts power supply to the USB device from the USB connection section when all communication links between the network and the network connection section are disconnected.

If all communication links between the network and the network device are disconnected, access to the USB device connected to the network device does not take place from any network. Accordingly there is no need for the USB device to be supplied with power for the purpose of accessing the USB device from network. According to the network device of the twelfth aspect, if all communication link between the network and the network device are disconnected, the power supply controller stops supplying power to the USB device from the USB connection section so that power consumption by the network device can be reduced. It is possible to determine whether communication link between the network and the network device have been disconnected by monitoring various types of packets and signals received from the network.

According to a thirteenth aspect of the invention, there is provided

the network device in accordance with any of the first to eleventh aspects wherein

the power supply controller interrupts power supply to the USB device from the USB connection section if all communication links between the network and the network connection section are disconnected, and if no communication link is reestablished thereafter between the network and the network connection section for a prescribed time period.

Even if all communication links between network and network connection section are disconnected, there is a possibility that a communication link between a network and a network connection section may be subsequently reestablished within a relatively short time and that an access to the USB device may take place. According to the network device of the thirteenth aspect, the power supply controller stops supplying power supply to the USB device from the USB connection section if all communication links between the network and the network connection section are disconnected and if no communication link is reestablished thereafter between the network and the network connection section for a prescribed time period. In other words, even after all communication links between the network and the network connection section are disconnected, power continues to be supplied to the USB device from the USB connection section until a prescribed time period has elapsed. Thus, if a communication link between network and a network connection section is reestablished within the prescribed time period after all communication links between the network and the network connection section are disconnected, the system can promptly respond to access to the USB device from the network in the event that a request to access the USB device arises. The prescribed time period may be set arbitrarily within a range in which power consumption by the network device can be suppressed.

In addition to the application to the network device discussed above, the present invention may also be embodied as a method of controlling a network device. Various other possible modes of practice include a computer programs for accomplishing the functions of such a device or method; or a recording medium having the program recorded therein. The various supplemental elements shown above may be added in these modes as well.

Where the present invention is embodied as a computer program or a recording medium having the program recorded therein, it may constitute the entire program for controlling the operations of the network device, or only that part for carrying out the functions of the present invention. Various computer-readable media may be employed as the recording medium, such as a flexible disk, CD-ROM, DVD-ROM, magnetooptical disk, IC card, ROM cartridge, printed matter imprinted with symbols such as a bar code, computer internal memory devices (memory such as RAM and ROM), and external memory devices.

These and other objects, features, aspects, and advantages of the present invention will become more apparent from the following detailed description of the preferred embodiments with the accompanying drawings.

### BRIEF DESCRIPTION OF THE DRAWINGS

FIG. 1 depicts the general features of a network system 1000 implementing a network device according to an embodiment of the present invention;

FIG. 2 depicts the general features of an access point 100;

FIG. 3 is a flowchart depicting the flow of a power supply control process from the access point 100 to a USB device 112 in Embodiment 1; and

FIG. 4 is a flowchart depicting the flow of a power supply control process from the access point 100 to a USB device 112 in Embodiment 2.

### DESCRIPTION OF EXEMPLARY EMBODIMENT

### A. Embodiment 1

### A1. Features of Network System

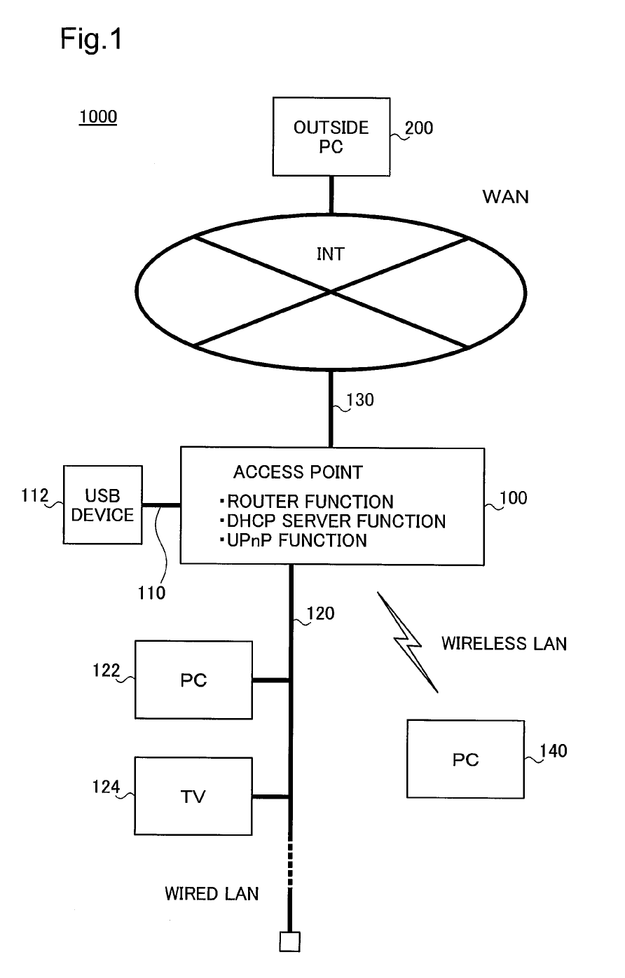

FIG. 1 depicts the general features of a network system 1000 implementing a network device according to an embodiment of the present invention. As illustrated, the network system 1000 of the present embodiment is configured to provide interconnection of a WAN (Wide Area Network) (in the present embodiment, the Internet INT), a wired LAN (Local Area Network), and a wireless LAN via an access point 100. The access point 100 of the present embodiment has router function, DHCP (Dynamic Host Configuration Protocol) server function, and UPnP (Universal Plug and Play) function.

The wired LAN and the access point 100 are connected via a LAN cable 120. The wired LAN includes a wired network-connectable personal computer (PC) 122 and a television receiver (TV) 124. The wireless LAN includes the access point 100 and a personal computer 140 having wireless communication function. The Internet INT and the access point 100 are connected via a WAN cable 130. An outside personal computer 200 is connected to the Internet.

The USB device 112 is connected to the access point 100 of the present embodiment by a USB cable 110. The USB device 112 may be a so-called USB hard disk or a USB camera, for example. This USB device 112 is utilizable through access from the personal computer 122 or the television receiver 124 on the wired LAN; from the personal computer 140 on the wireless LAN; or from the outside personal computer 200 connected to the Internet INT. The access point 100 corresponds to the network device recited in the Summary.

### A2. Features of Access Point

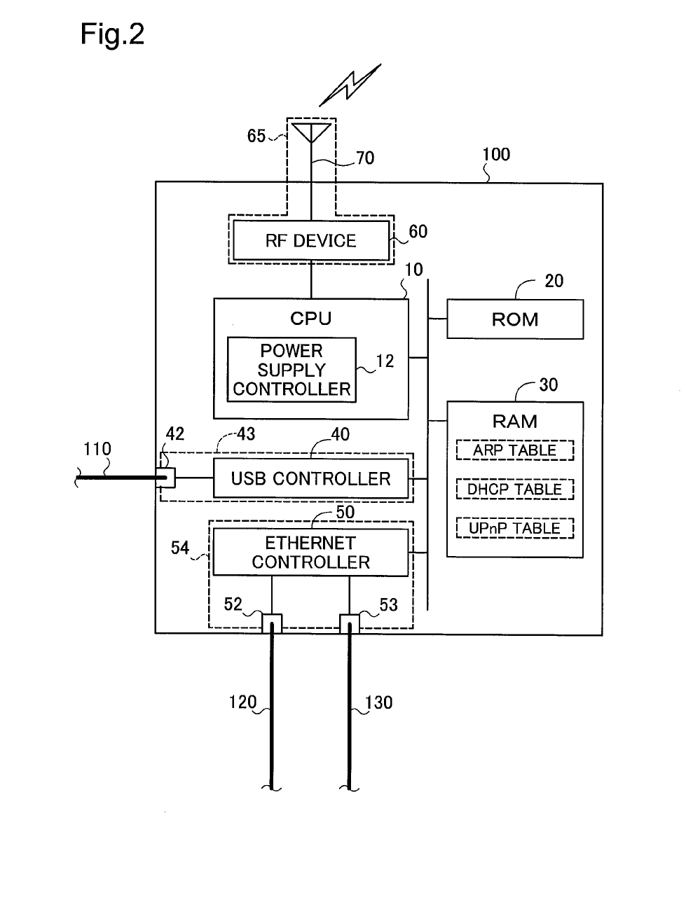

FIG. 2 depicts the general features of the access point 100. As illustrated, the access point 100 includes a CPU 10, a ROM 20, a RAM 30, a USB host controller 40, a USB port 42, an Ethernet TM controller 50, a LAN port 52, a WAN port 53, an RF device 60, and an antenna 70. The access point 100 is also equipped with a timer, not shown.

The USB host controller 40 controls operations of the USB device 112 via the USB cable 110 that is connected to the USB port 42. The USB port 42 is equipped with a USB-compliant power supply terminal, and the USB cable 110 has a power line. The USB host controller 40 is also furnished with a switch, not shown, for switching on and off delivery of power to the USB device 112. This switch is switched by the CPU 10. The USB host controller 40 and the USB port 42 correspond to the USB connection section recited in the Summary. The USB connection section is shown as the USB connection section 43 in FIG. 1.

Via the LAN cable 120 that is connected to the LAN port 52, the Ethernet controller 50 handles communication with the personal computer 122 and the television receiver 124 on the wired LAN. Via the Internet INT and the WAN cable 130 that is connected to the WAN port 53, the Ethernet controller 50 also handles communication with the outside personal computer 200 connected to the Internet INT. The Ethernet controller 50 and the LAN port 52 correspond to the wired LAN connection section (the network connection section) recited in the Summary. The Ethernet controller 50 and the WAN port 53 correspond to the WAN connection section (the network connection section) recited in the Summary. The network connection section is shown as the network connection section 43 in FIG. 1.

The RF device 60 and the antenna 70 are employed for wireless communication with the personal computer 140 on the wireless LAN. The RF device 60 is a device for transmitting and receiving wireless signals via the antenna 70. The RF device 60 and the antenna 70 correspond to the wireless LAN connection section (network connection section) recited in the Summary. The network connection section is shown as the network connection section 65 in FIG. 1.

The CPU 10 carries out control of the entire access point 100. By loading and executing a computer program saved in the ROM 20, the CPU 10 functions as a power supply controller 12 adapted to carry out a power feed control process, discussed later. During power supply control process, the power supply controller 12 monitors various packets and signals (e.g. link pulse signals) that are exchanged between the access point 100 and the various networked devices on the wireless LAN, the wired LAN, and the WAN (Internet INT); and on the basis of transmission and reception conditions with these devices makes decisions regarding communication link with network, specifically, whether communication links with devices were established, or whether communication links with devices were disconnected.

The power supply controller 12 decides that a communication link with the wired LAN was established if it receives from the wired LAN (the personal computer 122 or the television receiver 124) at least one of an ARP (Address Resolution Protocol) packet, a DHCP packet, a UPnP packet, and a line pulse signal for example. If the power supply controller 12 receives an ARP packet from the wired LAN, it is registered in the ARP table in the RAM 30. If the power supply controller 12 receives a DHCP packet from the wired LAN, it is registered in the DHCP table in the RAM 30. If the power supply controller 12 receives a UPnP packet from the wired LAN, it is registered in the UPnP table (UPnP port mapping table) in the RAM 30. These tables are deleted if the communication link with the wired LAN is disconnected, or if the validity period established for any table has expired.

### A3. Power Feed Control Process

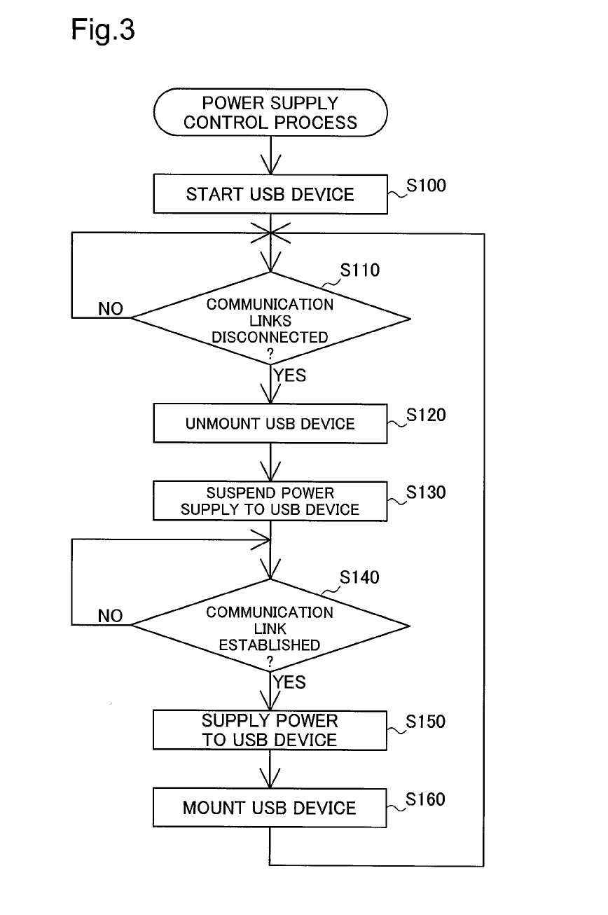

FIG. 3 is a flowchart depicting the flow of a power supply control process from the access point 100 to the USB device 112 in Embodiment 1. This process is executed by the CPU 10 (power supply controller 12) of the access point 100 on an ongoing basis after the access point 100 is started up.

First, when power to the access point 100 is turned on, the CPU 10 starts up the USB device 112 (Step S100). Specifically, the CPU 10 delivers power to the USB device 112 from the USB port 42 via the USB cable 110 and mounts the USB device 112 in the access point 100. In the present embodiment, to facilitate understanding, it is assumed that immediately after the access point 100 is started up, communication links are set up between the access point 100 and the wireless LAN (the personal computer 140), the wired LAN (the personal computer 122 or the television receiver 124), and/or the Internet INT (the outside personal computer 200).

Next, the CPU 10 decides whether communication links between all networks and the access point 100 were disconnected (Step S110). If there is a currently established communication link between any network and the access point 100 (Step S110: NO), the CPU 10 continues to feed power to the USB device 112 until all communication links between all networks and the access point 100 are disconnected.

If on the other hand communication links between all of the networks and the access point 100 were disconnected (Step S110: YES), the CPU 10 unmounts the USB device 112 from the access point 100 (Step S120) and suspends power supply to the USB device 112 (Step S130). If communication links between all of the networks and the access point 100 were disconnected, access of the USB device from the networks does not take place subsequently. Accordingly, there is no need to feed power to the USB device 112 to maintain it in standby mode in anticipation of access of the USB device 112 from a network.

Next, the CPU 10 decides whether a communication link was established between any of the networks and the access point 100 (Step S140). If there is no currently established communication link between any of the networks and the access point 100 (Step S140: NO), the CPU 10 suspends the feed of power to the USB device 112 until a communication link is established between a network and the access point 100.

If on the other hand a communication link was established between a network and the access point 100 (Step S140: YES), the CPU 10 feeds power to the USB device 112 (Step S150) and mounts the USB device 112 to the access point 100 (Step S160). In this way, the system can promptly respond to access to the USB device 112 from any network once a communication link has been established between any network and the access point 100. Subsequent to Step S160, power supply control process returns to Step S110.

With a conventional access point having a connected USB device, as long as power to the access point is on, power is constantly supplied to the USB device by the access point irrespective of the connection status between the networks and the access point, and is consumed by the USB device the entire time. According to the access point 100 of the present embodiment on the other hand, the CPU 10 (power supply controller 12) performs appropriate ON/OFF control of the feed of power from the access point 100 to the USB device 112 on the basis of the connection status (status of the communication link) of the networks and the access point 100. Specifically, if a communication link is established between any network and the access point 100, power is fed to the USB device 112 from the access point 100; whereas if communication link between all of the networks and the access point 100 are disconnected, the feed of power to the USB device 112 from the access point 100 is suspended. Consequently, power consumption by the access point 100 can be reduced.

### B. Embodiment 2

The features of the network system 1000 and the hardware configurations of the access point 100 of Embodiment 2 are identical to those in Embodiment 1. In Embodiment 2, power supply control process from the access point 100 to the USB device 112 is different from that in Embodiment 1. The power supply control process from the access point 100 to the USB device 112 is described below.

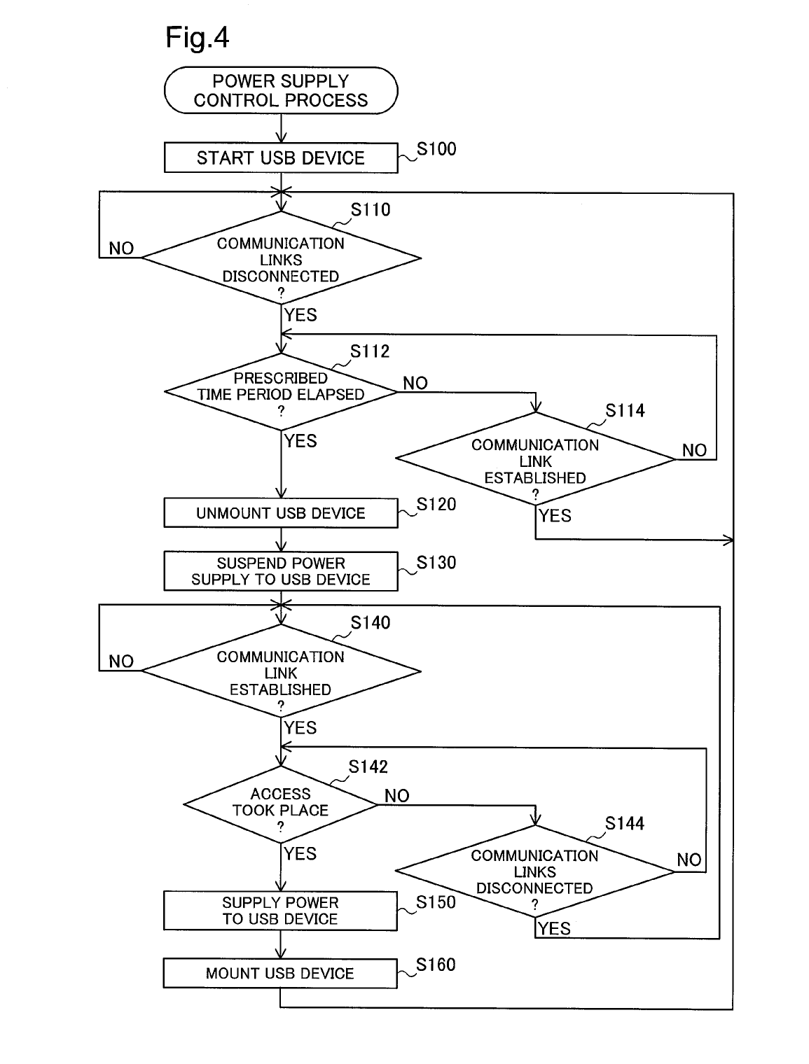

FIG. 4 is a flowchart depicting the flow of a power supply control process from the access point 100 to the USB device 112 in Embodiment 2. This process is executed by the CPU 10 (power supply controller 12) of the access point 100 on an ongoing basis after the access point 100 is started up. The power link control process in Embodiment 2 differs in part from the power supply control process in Embodiment 1. Consequently, those processes (steps) in the power supply control process of Embodiment 2 that differ from the power supply control process of Embodiment 1 are described here, while identical processes (steps) are not described.

According to the power supply control process of Embodiment 2, in Step S110, if it is decided that communication links between all of the networks and the access point 100 were disconnected (Step S110: YES), prior to Step S120 the CPU 10 decides if a prescribed time period elapsed after communication links between all of the networks and the access point 100 were disconnected (Step S112). Then, if the prescribed time period does not elapse after communication links between all of the networks and the access point 100 were disconnected (Step S112: NO), the CPU 10 decides whether a communication link is reestablished between any of the networks and the access point 100 (Step S114). If no communication link is reestablished between any of the networks and the access point 100 (Step S114: NO), the power supply control process returns to Step S112. If a communication link is reestablished between any of the networks and the access point 100 (Step S114: YES), the power supply control process returns to Step S110.

Then, in Step S112, if the prescribed time period elapsed after communication links between all of the networks and the access point 100 were disconnected (Step S112: YES), the power supply control process advances to Step S120. Even if all communication links between the networks and the access point 100 section are disconnected, there is a possibility that a communication link between a network and the access point 100 may be subsequently reestablished within a relatively short time, and that access of the USB device 112 may take place. According to the power supply control process of the present embodiment, power continues to be fed to the USB device 112 until a prescribed time period elapses after communication links between all of the networks and the access point 100 were disconnected. Thus, if a communication link between any network and the access point 100 is reestablished within the prescribed time period, the system can promptly respond to access to the USB device 112 from the network in the event of a request to access the USB device 112. The prescribed time period in Step S112 may be set freely within a range affording reduced power consumption by the access point 100.

According to the power supply control process of Embodiment 2, in Step S140, if a communication link is established between any network and the access point 100 (Step S140: YES), prior to Step S150, the CPU 10 additionally decides whether any access to the USB device 112 from a network has occurred (Step S142). Then, if no access to the USB device 112 from a network has occurred (Step S142: NO), the CPU 10 decides whether communication links between the networks and the access point 100 were disconnected (Step S144). If communication links between the networks and the access point 100 have not been disconnected, the power supply control process returns to Step S142. If communication links between the networks and the access point 100 were disconnected before any access to the USB device 112 from a network occurred (Step S144: YES), the power supply control process returns to Step S140.

Then, in Step S142, if access to the USB device 112 from a network has occurred (Step S142: YES), the power supply control process advances to Step S150. Even if a communication link is established between a network and the access point 100, it is not inevitable that access of the USB device from a network will take place. According to the power supply control process of the present embodiment, if a communication link is established between a network and the access point 100, and if additionally access of the USB device 112 from the network takes place, power is then fed to the USB device 112 from the access point 100. In other words, even if a communication link is established between a network and the access point 100, power is not fed to the USB device 112 from the access point 100 until access of the USB device 112 from the network has taken place. Thus, power consumption by the access point 100 can be reduced, as compared to a mode in which Steps S142 and 144 are not carried out.

According to the access point 100 of Embodiment 2 described above, the CPU 10 (power supply controller 12) performs appropriate ON/OFF control of supply of power from the access point 100 to the USB device 112 on the basis of the connection status (status of the communication link) of the networks and the access point 100. Consequently, power consumption by the access point 100 can be reduced.

### C. Modified Examples

While the invention has been shown herein in terms of several preferred embodiments, the invention is not limited to such embodiments and may be reduced to practice in various other modes without departing from the spirit thereof, such as the following modifications for example.

### C1. Modified Example 1

While the preceding embodiments described examples of implementation of the network device of the present invention in an access point 100, no limitation of the invention is imposed thereby. The invention is applicable generally to network devices having a connected USB device. Accordingly, it is possible for the invention to be implemented in a router having a connected USB device for example. In the preceding embodiments, the access point 100 is described as having broadband router function and DHCP server function, but it could lack these functions.

### C2. Modified Example 2

In the preceding embodiments, a wireless LAN, a wired LAN, and a WAN (Internet INT) serve as networks connected to the access point 100, but no limitation of the invention is imposed thereby. Any one or more of a wireless LAN, a wired LAN, and a WAN (Internet INT) may be connected as a network or networks to the access point 100. While the preceding embodiments describe implementation of the Internet INT as a WAN, a VPN (Virtual Private Network) could be implemented as well.

### C3. Modified Example 3

In the power supply control process of Embodiment 2 (see FIG. 4), the processes of Steps S112 and S114 may be omitted. Also, the processes of Steps S142 and S144 may be omitted.

### C4. Modified Example 4

In the power supply control processes according to the preceding embodiments (see FIGS. 3, 4), the USB device 112 starts up when the access point 100 is powered up (Step S100), but no limitation of the invention is imposed thereby. The process starting from Step S140 may be initiated when the access point 100 is powered up.

### C5. Modified Example 5

Some of the features implemented through hardware in the preceding embodiments could be substituted by software, and conversely some of the features implemented through software could be substituted by hardware.

While the invention has been described with reference to preferred exemplary embodiments thereof, it is to be understood that the invention is not limited to the disclosed embodiments or constructions. On the contrary, the invention is intended to cover various modifications and equivalent arrangements. In addition, while the various elements of the disclosed invention are shown in various combinations and configurations, which are exemplary, other combinations and configurations, including more less or only a single element, are also within the spirit and scope of the invention.

What is claimed is:

1. A network device comprising:
a network connection section configured to connect to network;
a USB connection section configured to connect a USB device and distribute power to the USB device; and
a power supply controller to control power supply to the USB device from the USB connection section, based on the connection status between the network and the network connection section.

2. The network device in accordance with claim 1 wherein
the power supply controller interrupts power supply to the USB device from the USB connection section in an event that all communication links between the network and the network connection section are disconnected.

3. The network device in accordance with claim 1 wherein
the power supply controller interrupts power supply to the USB device from the USB connection section in an event that, after all communication links between the network and the network connection section are disconnected, and a communication link between the network and the network connection section does not take place within a prescribed time period.

4. The network device in accordance with claim 1 wherein
the network include a wireless LAN,
the network connection section includes a wireless LAN connection section configured to connect to the wireless LAN, and
the power supply controller controls power supply to the USB device from the USB connection section based on connection status between the wireless LAN and the wireless LAN connection section.

5. The network device in accordance with claim 4 wherein
the power supply controller distributes power to the USB device on condition that a communication link is established between the wireless LAN and the wireless LAN connection section.

6. The network device in accordance with claim 4 wherein
the power supply controller distributes power to the USB device on condition that a communication link is established between the wireless LAN and the wireless LAN connection section, and additional condition that access of the USB device took place from the wireless LAN.

7. The network device in accordance with claim 1 wherein
the network include a wired LAN,
the network connection section include a wired LAN connection section configured to connect to the wired LAN, and
the power supply controller controls power supply to the USB device from the USB connection section based on connection status between the wired LAN and the wired LAN connection section.

8. The network device in accordance with claim 7 wherein
the power supply controller distributes power to the USB device on condition that a communication link is established between the wired LAN and the wired LAN connection section.

9. The network device in accordance with claim 8 wherein
the power supply controller decides that a communication link is established between the wired LAN and the wired LAN connection section, on condition that the wired LAN connection section receives from the wired LAN at least one of an ARP packet, a DHCP packet, a UPnP packet, or a link pulse signal.

10. The network device in accordance with claim 7 wherein
the power supply controller distributes power to the USB device on condition that a communication link is established between the wired LAN and the wired LAN connection section, and additional condition that access of the USB device took place from the wired LAN.

11. The network device in accordance with claim 10 wherein
the power supply controller decides that a communication link is established between the wired LAN and the wired LAN connection section, on condition that the wired LAN connection section receives from the wired LAN at least one of an ARP packet, a DHCP packet, a UPnP packet, or a link pulse signal.

12. The network device in accordance with claim 1 wherein
the network include a WAN;
the network connection section include a WAN connection section configured to connect to the WAN; and
the power supply controller controls power supply to the USB device from the USB connection section on based on connection status between the WAN and the WAN connection section.

13. The network device in accordance with claim 12 wherein
the power supply controller distributes power to the USB device on condition that a communication link is established between the WAN and the WAN connection section.

14. The network device in accordance with claim 12 wherein
the power supply controller distributes power to the USB device on condition that a communication link is established between the WAN and the WAN connection section, and additional condition that access of the USB device took place from the WAN.
